(19) United States
(12) Patent Application Publication
(10) Pub. No.: US 2025/0011560 A1
(43) Pub. Date: Jan. 9, 2025

(54) INSULATION FOAM AND METHODS OF MANUFACTURING THE SAME

(71) Applicant: UT-Battelle, LLC, Oak Ridge, TN (US)

(72) Inventors: Meghan Lamm, Oak Ridge, TN (US); Tolga Aytug, Knoxville, TN (US); Diana Hun, Lenoir City, TN (US); Kai Li, Farragut, TN (US); Som S. Shrestha, Knoxville, TN (US)

(21) Appl. No.: 18/761,762

(22) Filed: Jul. 2, 2024

Related U.S. Application Data
(60) Provisional application No. 63/524,969, filed on Jul. 5, 2023.

(51) Int. Cl. C08J 9/18; C08J 9/00; C08K 7/28

(52) U.S. Cl. CPC C08J 9/18; C08J 9/0066; C08K 7/28; C08J 2203/14; C08J 2203/22; C08J 2333/12; C08K 2201/001; C08K 2201/003; C08K 2201/005

(57) ABSTRACT

A thermal insulation composite is provided. The thermal insulation composite includes a polymer matrix, a thermal conductivity filler, and a physical blowing agent. The polymer matrix includes a thermoset or thermoplastic polymer. The thermal conductivity filler includes a porous-shell hollow-interior glass sphere (PHGS). The physical blowing agent includes an expandable thermoplastic microsphere (EMS). A method of manufacturing the composite is also provided. The method includes the step of combining a polymer matrix, a thermal conductivity filler, and a physical blowing agent to give a pre-heated composition. The method includes heating the pre-heated composition at a softening temperature for a softening time to give a pre-foamed composition. The method also includes heating the pre-foamed composition at a foaming temperature of between 150 to 250° C. for a foaming time of between 3 to 45 minutes to give the composite.

### CROSS-REFERENCE TO RELATED APPLICATIONS

This application claims the benefit of U.S. Provisional Application 63/524,969, filed Jul. 5, 2023, the disclosure of which is hereby incorporated by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to an insulation foam and associated methods of manufacture.

### BACKGROUND OF THE INVENTION

Stricter building codes and an increased demand for energy efficiency has driven development of thermal insulating composite materials. These thermal insulating composite materials typically comprise a thermoplastic or a thermoset matrix embedded with low thermal conductivity fillers, such as silica. The polymer-based matrix provides the mechanical stability to form a freestanding insulation product by acting as a binder to adhere the low thermal conductivity fillers together. The polymer-based matrix of the thermal insulating composite materials also eases processability. The polymer-based matrix can further decrease the overall composite cost by offsetting the cost of added fillers, which enhance flame retardancy and increase mechanical strength. The polymer-based matrix also facilitates achieving a desired thermal insulation performance by decreasing the overall thermal conductivity of the polymer system. Blowing agents are generally added to increase porosity and thermal resistivity of commercial insulation material. Most conventional blowing agents are produced using chlorinated hydrocarbons that deplete ozone and accumulate in the environment. Accordingly, there remains room for improvement in the field of insulation, and in particular systems and components to facilitate excellent thermal insulation while maintaining mechanical strength and that are environmentally friendly.

### SUMMARY OF THE INVENTION

A thermal insulation composite is provided. The thermal insulation composite comprises a polymer matrix, a thermal conductivity filler (i.e., a low thermal conductivity filler), and a physical blowing agent. The polymer matrix comprises a thermoset or thermoplastic polymer. The thermal conductivity filler comprises a porous-shell hollow-interior glass sphere (PHGS). The physical blowing agent comprises an expandable thermoplastic microsphere (EMS).

In some embodiments, the polymer matrix comprises a methacrylate resin. The methacrylate resin may be a copolymer of poly(methyl methacrylate-co-n-butyl methacrylate). The thermal conductivity filler may be present in the composite in an amount of from 1 to 40 wt. %, alternatively from 5 to 15 wt. %. In some embodiments the PHGS comprises a silica wall having a thickness of 0.5 to 2 μm and defines a hollow central cavity having a diameter of 10 to 120 μm. The physical blowing agent may be present in the composite in an amount of from 1 to 30 wt. %, alternatively from 10 to 20 wt. %. The EMS may comprise a polymer shell and an alkane based solvent comprising 2,2,4-trimethylpentane.

A method of manufacturing a thermal insulation foam composite is also provided. The method includes the step of combining a polymer matrix, a thermal conductivity filler, and a physical blowing agent to give a pre-heated composition. The polymer matrix comprises a thermoset or thermoplastic polymer, the thermal conductivity filler comprises a porous-shell hollow-interior glass sphere (PHGS), and the physical blowing agent comprises an expandable thermoplastic microsphere (EMS). The method further includes the step of heating the pre-heated composition at a softening temperature of between 65 to 200° C., alternatively 140 to 150° C., for a softening time of between 10 to 90 minutes, alternatively 25 to 35 minutes, to give a pre-foamed composition. In some embodiments, the method further includes the step of compressing the pre-foamed composition. The method also includes the step of heating the pre-foamed composition at a foaming temperature of between 85 to 250° C., alternatively 180 to 200° C., for a foaming time of between 3 to 90 minutes, alternatively 10 to 20 minutes, to give the thermal insulation foam composite.

These and other features of the invention will be more fully understood and appreciated by reference to the description of the embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1A is a graph of the density of several different exemplary insulation composites as a function of porous-shell hollow-interior glass sphere (PHGS) content weight % (wt. %).

FIG. 1B is a graph of the porosity (%) of several different exemplary insulation composites as a function of PHGS content (wt. %).

FIG. 1C is a graph of the thermal conductivity (mW/(m·K)) of several different exemplary insulation composites as a function of PHGS content (wt. %).

FIG. 1D is a graph of the insulation R-value per square inch (h-ft²-° F./Btu-in) of several different exemplary insulation composites as a function of PHGS content (wt. %).

FIG. 2A is a graph of the compressive strength (10% yield, kPa) for Examples 2-5.

FIG. 2B is a graph of the compressive strength (10% yield, kPa) as a function of density (g/cm³) for Examples 2-5.

FIG. 2C is a graph of the compressive strength (10% yield, kPa) for Examples 3-5.

### DETAILED DESCRIPTION OF THE CURRENT EMBODIMENTS

A low density, highly porous thermal insulation composite (“the composite”) is provided. The thermal insulation composite includes a polymer matrix, a thermal conductivity filler (i.e., a low thermal conductivity filler), and a physical blowing agent. The polymer matrix includes a thermoset or thermoplastic polymer. The thermal conductivity filler includes a hollow glass sphere (HGS) or a porous-shell hollow-interior glass sphere (PHGS). The physical blowing agent includes an expandable thermoplastic microsphere (EMS).

The polymer matrix enables greater ease and speed in processibility of the composite and serves as a binder to adhere to the thermally conductivity filler and provide mechanical stability to the composite and allow the composite to be freestanding. The polymer matrix is generally formed from a material having relatively high thermal resistance. The polymer matrix further decreases the cost of the composite by reducing the amount of generally more expensive thermally conductive filler required in the composite. In some embodiments, the polymer matrix comprises, alternatively consists essentially of, alternatively consists of a thermoplastic. Thermoplastic materials can be processed in a melt phase and effectively coat and bind a large volume of thermal conductivity filler and physical blowing agent in the composite. The polymer matrix is generally selected to have a relatively low glass transition temperature. The polymer matrix may have a glass transition temperature of 30 to 90° C., alternatively 40 to 50° C. The polymer matrix may comprise, alternatively consist essentially of, alternatively consists of a methacrylate resin. The methacrylate resin may be a copolymer of poly(methyl methacrylate-co-n-butyl methacrylate).

The thermal conductivity filler generally provides enhanced flame retardancy, increased mechanical strength, and facilitates excellent insulation performance by decreasing the overall thermal conductivity of the polymer system. The thermal conductivity filler comprises a hollow glass sphere (HGS) or a porous wall-hollow glass sphere (PHGS). Generally, the thermal conductivity filler comprises a multitude of hollow glass spheres or porous wall-hollow glass spheres. HGS and PHGS are spherical in shape with a hollow central cavity. HGS and PHGS have a hollow central cavity having diameters in a range of 10 to 120 μm surrounded by thin silica walls of 0.5 to 2 μm in thickness. Notably, these silica HGS and PHGS feature a relatively low density, greater chemical inertness, strong mechanical properties, and much lower thermal conductivity when compared with solid borosilicate glasses (0.1 W/m·K versus 1.4 W/m·K, respectively). These superior properties of silica HGS and PHGS facilitate the excellent mechanical strength and lightweight character of the composite. The superior properties of the silica HGS and PHGS further result in lower flammability and thermal conductivity of the composite when compared to conventional insulation foams composed of pristine materials. The thermal conductivity filler is present in the composite in an amount of from 1 to 40 wt. %, alternatively 5 to 15 wt. %, alternatively about 10 wt. %.

In some embodiments, the thermal conductivity filler comprises, alternatively consists essentially of, alternatively consists of PHGS. PHGS provides additional benefits to the composite when the thermal conductivity filler comprises PHGS. Each individual PHGS defines a tortuous network of nanometer-scale porous shell structure which produce an even lower density than is typical of HGS. Each individual PHGS features a highly permeable surface with increased surface area. This increased surface area helps to strengthen the interface of the thermal conductivity filler with the polymer matrix and increase the mechanical resiliency of the composite.

The physical blowing agent further facilitates the excellent insulation performance of the composite by increasing the porosity of the composite. Increasing porosity of insulation foams is generally desired because air has a lower thermal conductivity (0.0259 W/m·K at 20° C. and 1 bar) than the other components in the composite such as thermosets (˜0.1 W/m·K) and thermoplastics (˜0.2 W/m·K). Incorporation of the physical blowing agent effectively improves the thermal performance of the composite by minimizing the thermal conductivity contribution of the solid polymer fraction and increasing the formation of physical discontinuities within the foamed structure of the composite. The physical blowing agent includes an expandable thermoplastic microsphere (EMS). Generally, the physical blowing agent includes a multitude of EMS. EMS are a safer and more environmentally friendly way for producing thermoplastic insulation foams than conventional blowing agents. Each EMS includes a thin exterior polymer membrane shell that encapsulates a non-halogenated alkane based solvent. In some embodiments, the alkane based solvent comprises 2,2,4-trimethylpentane. If the EMS is processed at a temperature that exceeds a glass transition temperature (Tg) of the polymer membrane shell. As the temperature approaches the Tg the polymer membrane shell softens and the internal alkane-based solvent boils, resulting in expansion of the softened polymer membrane shell and an increase in the volume of the EMS. The polymer matrix typically has a relatively high melting or softening temperature (>120° C.), and the selection of the EMS is made such that the EMS does not have a decomposition temperature below the melting or softening temperature used in the polymer matrix. The physical blowing agent is present in the composite in an amount of from 1 to 30 wt. %, alternatively from 10 to 20 wt. %.

A method of manufacturing a thermal insulation foam composite is also provided. The method includes the step of combining a polymer matrix, a thermal conductivity filler, and a physical blowing agent to give a pre-heated composition. The method also includes heating the pre-heated composition at a softening temperature of between 40 to 200° C., alternatively 140 to 150° C., alternatively about 145° C., for a softening time of between 10 to 90 minutes, alternatively 25 to 35 minutes, alternatively about 30 minutes, to give a pre-foamed composition. The method may further include the step of compressing the pre-foamed composition. The method also includes the step of heating the pre-foamed composition at a foaming temperature of between 85 to 250° C., alternatively 180 to 200° C., alternatively about 190° C., for a foaming time of between 3 to 90 minutes, alternatively 10 to 20 minutes, alternatively 15 minutes, to give the thermal insulation foam composite. The polymer matrix includes a thermoset or thermoplastic polymer. The thermal conductivity filler includes a porous-shell hollow-interior glass sphere (PHGS). The physical blowing agent includes an expandable thermoplastic microsphere (EMS).

### EXAMPLES

The polymer matrix is Elvacite 4021, a copolymer of poly(methyl methacrylate-co-n-butyl methacrylate) (PMMA-co-BMA), provided by ChemPoint. Elvacite 4021 has a molecular weight of 145 KDa and a density of 1.079 g/cm³. The thermal conductivity filler is porous hollow glass microspheres (PHGS, GL 1756) with a bulk density of 0.35 g/cm³ and diameters in the range of 40 to 90 μm, purchased from Mo-Sci Specialty Products. The physical blowing agent is Expancel 980 DU 120 (Nouryon), expandable microspheres, provided by The Kish Company. The Expancel 980 DU 120 has a density of ≤14 kg/m³, an initial expansion temperature of 158 to 178° C., and a maximum working temperature of 215 to 235° C. The Expancel 980 DU 120 are filled with 2,2,4-trimethylpentane.

### Preparation Method 1

Polymer matrix, thermal conductivity filler, and physical blowing agent were placed in vials in the amounts recorded in Table 1 and thoroughly mixed for about 1 minute by hand using a shaking motion to give a powder composition. After mixing, the powder composition was poured into an aluminum dish (63 mm diameter) that had been sprayed with a mold release (CRC Lecithin Mold Release, Grainger) and then placed in an oven at an initial temperature of 145° C. for 30 minutes to soften the polymer matrix. Following the heat treatment, the dish was removed and covered with an aluminum foil and a flat ¼ inch (6.35 mm) thick aluminum plate to provide slight compression to ensure homogenous foam formation. The oven is then set to a final temperature of 190° C. for an additional 15 minutes to expand the physical blowing agent. The dish was then removed and allowed to cool at room temperature before carefully removing the foam composite from the mold. The composite was then polished using a fine grit sandpaper (P180 grit aluminum oxide) to produce a flat top and bottom surface for thermal properties characterization. All produced samples displayed a homogenous, uniform foam structure across the sample.

TABLE 1
Examples 1-10 Composite Compositions

| | (A) Polymer | (B) Thermal | (C) Physical |
|---|---|---|---|
| | Matrix | Conductivity Filler | Blowing Agent |
| Example | (wt. %) | (wt. %) | (wt. %) |
| 1 | 95 | 0 | 5 |
| 2 | 90 | 0 | 10 |
| 3 | 80 | 10 | 10 |
| 4 | 70 | 20 | 10 |
| 5 | 60 | 30 | 10 |
| 6 | 85 | 0 | 15 |
| 7 | 75 | 10 | 15 |
| 8 | 65 | 20 | 15 |
| 9 | 55 | 30 | 15 |
| 10 | 80 | 0 | 20 |

TABLE 2
Examples 1-10 Composite Volume

| | (A) Polymer | (B) Thermal | (C) Physical |
|---|---|---|---|
| | Matrix | Conductivity Filler | Blowing Agent |
| Example | (vol. %) | (vol. %) | (vol. %) |
| 1 | 19.3 | 0 | 80.7 |
| 2 | 10.2 | 0 | 89.8 |
| 3 | 8.9 | 3.4 | 87.7 |
| 4 | 7.6 | 6.7 | 85.7 |
| 5 | 6.3 | 9.9 | 83.8 |
| 6 | 6.7 | 0 | 93.3 |
| 7 | 5.8 | 2.4 | 91.8 |
| 8 | 4.9 | 4.7 | 90.4 |
| 9 | 4.1 | 7.0 | 88.9 |
| 10 | 4.8 | 0 | 95.2 |

Compressive strength was measured by compressing cylindrical specimens (63 mm diameter, 25 mm height) corresponding to each of Examples 1-10 at room temperature via a servo-hydraulic testing machine with a 100,00 lb loading cell at a speed of 0.05 inch/min. Four specimens of each sample were tested to provide average and standard deviation values. The test of compressive strength was carried out according to the ASTM 1621 standard, and the compressive strength of the samples is determined as the stress at 10% yield.

Thermal conductivity of the Examples 1-10 was measured in a TA Instruments (LaserComp) Fox 304 heat flow meter apparatus (HFMA). A sample corresponding to each Example 1-10 is sandwiched between two independently temperature-controlled plates equipped with heat flux transducers that measure the heat flows through the tested samples. The conductivity of the samples is then determined following Fourier's law using measured heat flow, temperature difference across the samples, and the sample thickness. The HFMA was calibrated using NIST standard reference materials (SRM). The thermal conductivity tests were determined according to ASTM C518-21, a standard test method commonly used by the insulation industry for thermal performance evaluation.

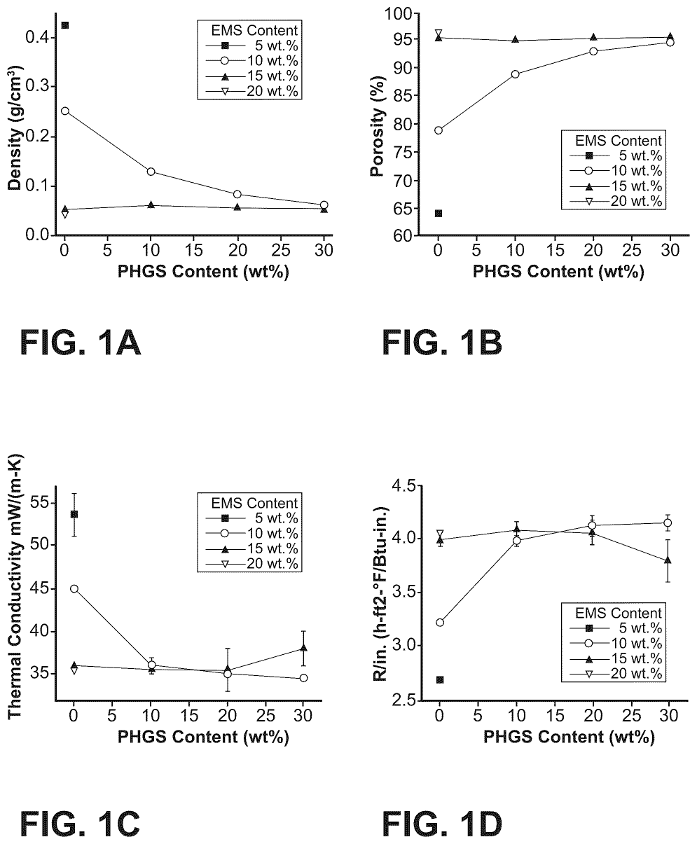

As shown in FIG. 1A, the density of the exemplary composites was plotted as a function of the thermal conductivity filler weight percents. As seen in FIG. 1A, examples with relatively lower weight loadings of physical blowing agent (e.g., Examples 1-5) demonstrate relatively high densities. Correspondingly, examples with relatively high weight loadings of physical blowing agent (e.g., Examples 6-10) demonstrate relatively low densities. Holding the weight loading of the physical blowing agent constant, the density of the exemplary composites decreases as the weight loading of the thermal conductivity filler is increased. This is demonstrated when comparing Examples 2-5, with Example 2 having the lowest weight loading of the thermal conductivity filler and the highest density and Example 5 having the highest weight loading of the thermal conductivity filler and the lowest density.

As shown in FIG. 1B, the porosity of the exemplary composites was plotted as a function of the thermal conductivity filler weight percents. As seen in FIG. 1B, examples with relatively high weight loadings of physical blowing agent (e.g., Examples 6-10) demonstrate relatively high porosity. Correspondingly, examples with relatively low weight loadings of physical blowing agent (e.g., Examples 1-5) demonstrate relatively low porosities. Holding the weight loading of the physical blowing agent constant, the porosity of the exemplary composites increases as the weight loading of the thermal conductivity filler is increased. This is demonstrated when comparing Examples 2-5, with Example 2 having the lowest weight loading of the thermal conductivity filler and the lowest porosity and Example 5 having the highest weight loading of the thermal conductivity filler and the highest porosity.

As shown in FIG. 1C, the thermal conductivity, measured in mW/(m-K), of the exemplary composites was plotted as a function of the thermal conductivity filler weight percents. As seen in FIG. 1C, examples with relatively high weight loadings of physical blowing agent (e.g., Examples 6, 7, 8, and 10) demonstrate relatively low thermal conductivity. Correspondingly, examples with relatively low weight loadings of physical blowing agent (e.g., Examples 1 and 2) demonstrate relatively high thermal conductivity. Notably, examples that have weight loadings of the thermal conductivity filler at either extreme (i.e., at 0 wt. % or 30 wt. %) may demonstrate higher thermal conductivity. Therefore, maintaining the weight loading of physical blowing agent above 10 wt. % and the weight loading of thermal conductivity filler between 5 to 25 wt. % is ideal for minimizing thermal conductivity in insulation applications.

As shown in FIG. 1D, insulation R-value per square inch (h-ft²-° F./Btu-in) of the exemplary composites was plotted as a function of the thermal conductivity filler weight percents. As seen in FIG. 1D, examples with relatively high weight loadings of physical blowing agent (e.g., Examples 6, 7, 8, and 10) demonstrate relatively high R-values. Correspondingly, examples with relatively low weight loadings of physical blowing agent (e.g., Examples 1 and 2) demonstrate relatively low R-values. Notably, examples that have weight loadings of the thermal conductivity filler at either extreme (i.e., at 0 wt. % or 30 wt. %) may demonstrate lower R-values. Therefore, maintaining the weight loading of physical blowing agent above 10 wt. % and the weight loading of thermal conductivity filler between 5 to 25 wt. % is ideal for maximizing R-values. It will further be appreciated that the inclusion of both the thermal conductivity filler and the physical blowing agent has beneficial synergistic insulation effects.

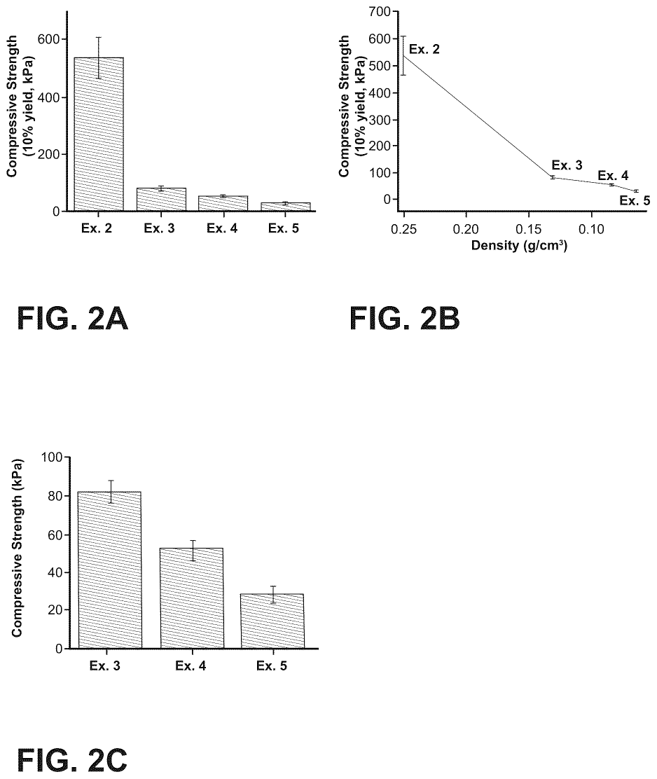

As shown in FIG. 2A, compressive strength, measured in kPa, was plotted for each of Examples 2-5. Examples 2-5 all have the same weight loading of physical blowing agent, but having varying weight loadings of thermal conductivity filler. Example 2 has 0% by weight of thermal conductivity filler, while Example 5 has 30% by weight of thermal conductivity filler. Examples 3 and 4 have intermediate values of 10 wt. % and 20 wt. %, respectively. As depicted in FIG. 2A, the inclusion of any thermal conductivity filler severely reduces the compressive strength of the exemplary composites. As the weight loading of the thermal conductivity filler increases, the compressive strength of the composite continues to fall, although each incremental increase in the weight loading of thermal conductivity filler results in a smaller marginal decrease of compressive strength.

As shown in FIG. 2B, compressive strength, measured in KPa, was plotted for each of Examples 2-5 as a function of density, measured in g/cm³. As discussed regarding FIG. 1A above, Example 2 is the densest of Examples 2-5, while Example 5 is the least dense and Examples 3 and 4 have intermediate density values. As shown in FIG. 2B, compressive strength is directly proportional to density. As the density of an exemplary composite decreases, so too does the compressive strength. Therefore, there is a tradeoff between effective insulation and compressive strength.

FIG. 2C is a zoomed in view of FIG. 2A, allowing for a more precise assessment of the compressive strengths of Examples 2-5.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. If not otherwise defined herein, “about” is defined as within ±25%, alternatively ±10%, or alternatively ±5%.

1. A thermal insulation composite comprising:
(A) a polymer matrix comprising a thermoset or thermoplastic polymer;
(B) a thermal conductivity filler comprising a porous-shell hollow-interior glass sphere (PHGS); and
(C) a physical blowing agent comprising an expandable thermoplastic microsphere (EMS).

2. The thermal insulation composite of claim 1, wherein the (A) polymer matrix comprises a methacrylate resin.

3. The thermal insulation composite of claim 2, wherein the methacrylate resin is a copolymer of poly(methyl methacrylate-co-n-butyl methacrylate).

4. The thermal insulation composite of claim 1, wherein the (B) thermal conductivity filler is present in the composite in an amount of from 1 to 40 wt. %.

5. The thermal insulation composite of claim 4, wherein the (B) thermal conductivity filler is present in the composite in an amount of from 5 to 15 wt. %.

6. The thermal insulation composite of claim 1, wherein the PHGS comprises a silica wall having a thickness of 0.5 to 2 μm and defining a hollow central cavity having a diameter of 10 to 120 μm.

7. The thermal insulation composite of claim 1, wherein the EMS comprises a polymer shell and an alkane based solvent comprising 2,2,4-trimethylpentane.

8. The thermal insulation composite of claim 1, wherein the (C) physical blowing agent is present in the composite in an amount of from 1 to 30 wt. %.

9. The thermal insulation composite of claim 4, wherein the (C) physical blowing agent is present in the composite in an amount of from 10 to 20 wt. %.

10. A method of manufacturing a thermal insulation foam composite, the method comprising the steps of:
combining (A) a polymer matrix, (B) a thermal conductivity filler, and (C) a physical blowing agent to give a pre-heated composition;
heating the pre-heated composition at a softening temperature of between 100 to 200° C. for a softening time of between 10 to 90 minutes to give a pre-foamed composition;
heating the pre-foamed composition at a foaming temperature of between 150 to 250° C. for a foaming time of between 3 to 45 minutes to give the thermal insulation foam composite;
wherein the (A) polymer matrix comprises a thermoset or thermoplastic polymer, the (B) thermal conductivity filler comprises a porous-shell hollow-interior glass sphere (PHGS); and the (C) physical blowing agent comprises an expandable thermoplastic microsphere (EMS).

11. The method of 10, wherein the method further comprises the step of compressing the pre-foamed composition.

12. The method of 11, wherein the softening temperature is from 140 to 150° C.

13. The method of claim 10, wherein the foaming temperature is from 180 to 200° C.

14. The method of claim 10, wherein the softening time is from 25 to 35 minutes.

15. The method of claim 10, wherein the foaming time is from 10 to 20 minutes.
